(19) United States
(12) Patent Application Publication
(10) Pub. No.: US 2013/0203097 A1
(43) Pub. Date: Aug. 8, 2013

(54) SUBSTRATES THE FLUORESCENCE OF WHICH IS SUPPRESSED, PREPARATION THEREOF, AND USE THEREOF FOR IDENTIFYING, DETECTING, AND ASSAYING LEGIONELLA PNEUMOPHILIA

(71) Applicants: Herve Poras, Bailly (FR); Tanja Ouimet, Paris (FR); Marie-Claude Fournie-Zaluski, Paris (FR)

(72) Inventors: Herve Poras, Bailly (FR); Tanja Ouimet, Paris (FR); Marie-Claude Fournie-Zaluski, Paris (FR)

(73) Assignee: PHARMALEADS, Paris (FR)

(21) Appl. No.: 13/810,870

(22) PCT Filed: Jul. 21, 2011
(86) PCT No.: PCT/EP2011/062565

§ 371 Date: Mar. 29, 2013

(30) Foreign Application Priority Data
Jul. 21, 2010 (FR) 1055970

(51) Int. Cl. G01N 21/64

(52) U.S. Cl. CPC G01N 21/6486
USPC 435/23; 530/328; 530/329

(57) ABSTRACT

The present disclosure includes the use of an R—(X)ₙ-Fluo-Rep-(Gly)ₘ-Z—NH₂ peptide for detecting and assaying the activity of the major surface protease of Legionella pneumophilia. This disclosure also includes a method for detecting and quantifying Legionella pneumophilia in any medium likely to be contaminated with the bacterium, for example a domestic hot water supply and cooling tower circuits.

### CROSS-REFERENCE TO RELATED APPLICATIONS

This application is a National Phase Entry of International Application No. PCT/EP2011/062565, filed on Jul. 21, 2011, which claims priority to French Patent Application Serial No. 1055970, filed on Jul. 21, 2010, both of which are incorporated by reference herein.

### BACKGROUND AND SUMMARY

The present invention relates to a novel method for detecting and for assaying Legionella of the species Legionella pneumophila in all media potentially contaminated by this bacterium.

Legionella are aquatic bacteria that are encountered in natural waters (lakes, rivers and marshes) and which develop particularly in lukewarm water (between 25 and 45° C.). These bacteria are responsible in humans for acute respiratory infections, Legionella infections (Legionnaire's disease, Pontiac fever) as well as non-specific extra-pulmonary biological anomalies. To date, around 50 species of Legionella have been identified. The species L. pneumophila is the most widespread and the most virulent for humans. Among the 16 serogroups of L. pneumophila (representing 90 to 95% of clinical cases), the serogroup (SG) 1 is responsible for 84% of human infections. The infection appears following the inhalation of aerosols charged with Legionella, which reach the pulmonary alveoli. The bacteria then develop in the alveolar macrophages then in the pulmonary tissue. The persons affected by this disease are, in general, the elderly and/or those suffering from serious immune deficiencies.

Legionnaire's disease is considered as an opportunistic infection. In France, data from the obligatory declaration report 1527 cases of Legionellosis declared in 2005, representing an incidence of 2 cases per 100000 inhabitants compared to an estimation of 8000 to 18000 cases of Legionellosis every year in the United States.

Legionella naturally colonises water supply networks. They are present in the heated waters of air conditioning systems, cooling towers (TAR), in domestic hot water networks (electric water heaters) where they multiply in an optimal manner between 30° and 40° C. They can contaminate establishments such as swimming pools, equipment in spas, fountains and, in hospitals, humidifiers, respirators or nebulisers. In fact, Legionella are the most often found, in very large quantity, in biofilms (Declerck et al., Curr. Microbiol., 2007, 55, 5, 435-440) associated with protozoa (amoeba), which, by ingesting them, enable the intracellular growth and replication thereof. The detection of Legionella is subject to regulations in establishments at risk. Current standards for the detection and the enumeration of Legionella are based on the use of culture techniques (international standard ISO 11731 and French standard AFNOR NF R90-431). These techniques are very sensitive, but long to implement (10 to 15 days), delicate because the Legionella have a low growth rate and they require qualified personnel to establish the diagnosis.

Alternative approaches have been developed over the last few years:

1—The real time PCR technique (RT-PCR). Since 2006, an experimental standard (XP T 90-47) covers this method that is rapid, sensitive and specific. However, no strict correlation exists between UFC and Genome Units (GU) accessible via PCR, which poses a problem. Furthermore, this technique requires particular laboratory equipment, qualified personnel and has a high cost.

2—Immunochromatography or immunofluorescence detection techniques. These immunological approaches are methodologically simpler, but they require antibodies of large specificity vis-à-vis the species searched for and the sensitivity thereof varies considerably as a function of the detection method used. These approaches also require suitable equipment and personnel and the cost price is high. At present, these techniques are not used routinely.

3—The fluorescence in situ hybridization (FISH) method. This recent method (Declerck and Ollevier, Methods Mol. Biol., 2006, 345, 175-183) is sensitive and rapid, but it requires, like the preceding methods, dedicated equipment, a high cost and a qualified personnel, which makes the technique marginal.

4—ATPmetry. This method makes it possible to detect the concentration of metabolically active bacteria and represents an efficient warning means. ATPmetry kits are available at low cost, but are not Legionella specific.

None of these methods is at one and the same time specific, sensitive, rapid, useable in the field and of a reasonable cost price. There thus still exists a need for a novel method for detecting and assaying Legionella having all the qualities defined previously. The present inventors provide such a method, on the basis of measuring the activity of a specific protease secreted by the bacterium.

In 1979, a protease secreted by different strains of L. pneumophila was highlighted (Baine et al., Journal of Clinical Microbiology, 1979, 9, 3, 453-456). It exhibits proteolytic activity on different proteins of the serum (Müller, Infect. Immun., 1980, 27, 51-53) as well as on collagen, casein and gelatine (Thompson et al., Infect. Immun., 1981, 34, 299-302). It is the most abundant protein found in the culture supernatants of L. pneumophila, hence its name Major Secretory Protein, Msp.

Finally, Msp forms part of numerous virulence factors characterised in the family Legionella: it exhibits cytotoxic and haemolytic actions (Dowling et al., Microbiological Reviews, 1992, 56, 1, 32-60), in particular in guinea pigs, causing haemorrhages and necrotic lesions (Conlan et al., J. Gen. Microbiol., 1986, 132, 1565-1574, Rosenfeld et al., FEMS Microbiol. lett., 1986, 37, 51-58). It is interesting to note that these cytotoxic and haemolytic properties are directly linked to the proteasic activity of the Msp. In fact, the mutation of the residue Glu³⁷⁸, involved in the catalytic act, leads to an inactive and non-cytotoxic protease (Moffat et al., Mol. Microbiol., 1994, 12, 693-705).

A chromogenic substrate, MeO-Suc-Arg-Pro-Tyr-pNA (S-2586), primitively developed for the characterisation of α-chymotrypsin (Berdal et al., European Journal of Clinical Microbiology, 1982, 1, 1, 7-11), has been used for detecting Msp in different strains of Legionella (McIntyre et al., Acta Pathol. Microbiol. Immunol. Scand., 1991, 99, 4, 316-320), despite the lack of selectivity of said substrate. Out of 283 strains of Legionella pneumophila tested, 282 degraded the substrate. Out of 6 other species of Legionella, only 2 responded positively as well as certain species of Pseudomonas aeruginosa (22 out of 40). These preliminary results thus show a relative specificity for the Msp of L. pneumophila compared to other pathogens for the substrate S-2586 which remains however not very sensitive and not sufficiently selective.

Given the important properties of Msp, in other words the abundance of its release in the aqueous medium, its link with the pathogenicity of the bacterium and its specificity vis-à-vis proteins excreted by other pathogens, the present inventors have used Msp as a marker for the presence of Legionella pneumophila in different water networks. With this aim, a specific, sensitive and rapid method of detection and quantification of said protease has been developed. A statistically significant correlation between the quantity of Msp assayed and the quantity of Legionella pneumophila present in the sample of water analysed has been established.

Msp has been primitively purified from culture supernatants of Legionella pneumophila (Dreyfus and Iglewski, Infect. Immun., 1986, 51, 736-743): it is a zinc metallopeptidase of 38 kDa, in the mature form thereof, of isoelectric point 4.20 and the optimum functioning pH of which is comprised between 5.5 and 7.5. The access number of the Msp of Legionella pneumophila is P21347 in Swissprot/UniProtKB. The complete sequence of the Msp of Legionella pneumophila is composed of 543 amino acids distributed as follows (residues 1-24: peptide signal, residues 25-207: “propeptide” sequence, residues 208-543: zinc metalloprotease).

It has important sequence homologies with Pseudolysin (Pseudomonas aeruginosa elastase, Black et al., J. Bacteriol, 1990, 172, 2608-2613) as well as with Thermolysin. These three enzymes form part of the family M4 of zinc metallopeptidases. An alignment of the sequences of pseudolysin and Msp shows a homology of 62.9% and makes it possible to verify that the Msp has the two consensus sequences of this family, namely the sequences ³⁷⁷HEVSH³⁸¹X₁₉⁴⁰¹ExxxD⁴⁰⁵ in which H³⁷⁷, H³⁹¹ and E⁴⁰¹ are ligands of zinc and E³⁷⁸ is involved in the catalytic act.

The purpose of the present invention is to provide a novel assaying test enabling the aforementioned problems, which are linked to existing tests, to be overcome. In particular, said novel assaying test according to the invention is specific, sensitive, rapid, useable in the field and of a reasonable cost price.

The present invention is more particularly based on the use by the inventors of peptide substrates selective for Msp which make it possible to detect and to assay the activity of the enzyme. Said peptide substrates comprise a Fluo fluorophore, in other words a synthetic amino acid having a high fluorescence capacity by virtue of the presence of a fluorigenic side chain. Advantageously, said fluorescence of the Fluo radical is zero or substantially reduced when a Rep repressor is situated in the same molecule near to the Fluo fluorophore. Consequently, the natural fluorescence of the Fluo fluorophore can only be apparent from the moment where the Fluo radical is no longer subjected to the repressor effect of the Rep radical: for example, when the peptide substrate is cleaved by the enzyme, which leads to the physical separation of the Fluo and Rep radicals.

The first subject matter of the present invention is thus a peptide substrate selective for Msp, of formula (I):

R—(X)ₙ-Fluo-Rep-(Gly)ₘ-Z—NH₂ (I)

in which,
Fluo is an α-amino acid of configuration (L), having on its side chain a fluorigenic group,
Rep is an amino acid of configuration (L) selected from (3-NO₂)Tyr and (4-NO₂)Phe, on the understanding that when Fluo is pyrenylalanine, Rep is (3-NO₂)Tyr,
R is a group selected from the groups acetyl, succinyl and methoxysuccinyl,
X is an α-amino acid of configuration (L) selected from the group consisting of: Gly, Ser, homo-Ser, Lys, homo-Lys, Arg, homo-Arg and Orn,
Z is a positively charged α-amino acid, and
n and m are two natural whole numbers, with n comprised between 0 and 3 and m comprised between 0 and 2.

“α-amino acid” according to the present invention is taken to mean all the natural α-amino acids in L form, as well as non-natural α-amino acids. The term “natural α-amino acid” represents among others the following α-amino acids: glycine (Gly), alanine (Ala), valine (Val), leucine (Leu), isoleucine (Ile), serine (Ser), threonine (Thr), phenylalanine (Phe), tyrosine (Tyr), tryptophan (Trp), cysteine (Cys), methionine (Met), proline (Pro), aspartic acid (Asp), asparagine (Asn), glutamine (Gln), glutamic acid (Glu), histidine (His), arginine (Arg), and lysine (Lys). The non-natural α-amino acids according to the invention comprise non proteogenic α-amino acids, such as ornithine (Orn), homolysine (homo-Lys), homoarginine (homo-Arg), allylglycine, tert-leucine, 2-amino-adipic acid, 1-amino-1-cyclobutanecarboxylic acid, 1-amino-1-cyclohexanecarboxylic acid, 1-amino-1-cyclopentanecarboxylic acid, 2-aminobutanoic acid, 1-aminoindane-1-carboxylic acid, azetidine-2-carboxylic acid, (2S,4R)-4-benzyl-pyrrolidine-2-carboxylic acid, γ-carboxyglutamate, 2-cyclohexylalanine, citrulline, 5-hydroxylysine, 2,3-diamino-propionic acid, hippuric acid, homocyclohexylalanine, homophenylalanine, 3-hydroxyproline, 4-hydroxyproline, 3-methylhistidine, 7-methyllysine, indoline-2-carboxylic acid, α-methyl-alanine, norleucine, norvaline, octahydroindole-2-carboxylic acid, phenylglycine, 4-phenyl-pyrrolidine-2-carboxylic acid, pipecolic acid, propargylglycine, 3-pyridinylalanine, 4-pyridinylalanine, sarcosine, 1,2,3,4-tetrahydroisoquinoline-1-carboxylic acid, or I,2,3,4-tetrahydroisoquinoline-3-carboxylic acid.

The non-natural α-amino acids according to the invention also comprise, for example, all the natural α-amino acids as defined above, in the D form thereof. The non-natural α-amino acids according to the invention also comprise natural α-amino acids, as defined above, in which said α-amino acids comprise a side chain modified to include a fluorigenic group. The term “side chain of an amino acid” represents the fragment borne by the a carbon of an amino acid. For example, the side chains of natural amino acids such as glycine, valine, alanine and aspartic acid correspond to the hydrogen atom, to isopropyl, methyl and CH₂COOH groups respectively.

“Fluorigenic group” is taken to mean according to the present invention a chemical group capable of emitting a fluorescence signal after excitation at a wavelength corresponding to its absorption maximum. Preferably, Fluo is selected from the following amino acids: (L)-(I-pyrenyl)-alanine, (L)-Nε(retroAbz)-Lys, (L)-(7-methoxycoumarin-4-yl)-alanine, (L)-((6,7-dimethoxy-coumarin-4-yl)-alanine, (L)-Nβ(pyrenylacetyl)-Dap, (L)-Nγ(pyrenylacetyl))-Dab, (L)-Nδ-(pyrenylacetyl)-Orn, (L)-Nε-(pyrenylacetyl)-Lys, (L)-S-(I-pyrenemethyl)-Cys, (L)-0-(I-pyrenemethyl)-Ser. Preferentially, the Rep radical is (3-NO₂)Tyr.

In a preferred aspect of the invention, Z is a positively charged amino acid of configuration (L). In an even more preferred manner, Z is selected from the (L)-Lys, (L)-homo-Lys, (L)-Orn, (L)-Arg, (L)-homo-Arg. The peptides are advantageously protected in N-terminal positions by a group R=acetyl, succinyl or methoxysuccinyl, and in C-terminal position by an amide to avoid any non-specific degradation by amino- or carboxy-peptidases, which could be present in the medium.

In a more preferential manner, the subject matter of the invention is a peptide substrate selected from the group consisting of:

Compound 1 - Ac-Ser-Lys-Gly-Pya-(3-NO2)Tyr-
Gly-Gly-Lys-NH2
Compound 2 - Ac-Ser-Lys-Gly-Pya-
(3-NO2)Tyr-Gly-Lys-NH2
Compound 3 - Ac-Ser-Lys-Gly-Pya-(3-NO2)Tyr-Lys-NH2
Compound 4 - Ac-Ser-Arg-Gly-Pya-(3-NO2)Tyr-Gly-
Gly-Lys-NH2
Compound 5 - Ac-Arg-Gly-Pya-(3-NO2)Tyr-
Gly-Gly-Lys-NH2
Compound 6 - Ac-Ser-homo-Arg-Gly-Pya-(3-NO2)Tyr-
Gly-Gly-Lys-NH2
Compound 7 - Ac-Ser-Orn-Gly-Pya-(3-NO2)Tyr-Gly-
Gly-Lys-NH2
Compound 8 - Ac-Ser-Lys-Gly-Pya-(3-NO2)Tyr-Orn-NH₂
Compound 9 - Ac-Ser-Lys-Gly-Pya-(3-NO2)Tyr-
homo-Lys-NH2
Compound 10 - Ac-homo-Ser-Lys-Gly-Pya-(3-NO2)Tyr-
Orn-NH2
Compound 11 - Ac-Ser-Lys-Gly-Pya-(3-NO2)Tyr-Arg-NH2
Compound 12 -Ac-Ser-Lys-Gly-Pya-(3-NO2)Tyr-
homo-Arg-NH2,
and
Compound 13 - Ac-Ser-Lys-Gly-(ε-Abz)Lys-
(3-NO2)Tyr-Orn-NH2.

In an even more preferential manner, the subject matter of the invention is a peptide substrate selected from the group consisting of the compounds 1, 8 and 12 as defined above. The preparation of the peptide substrates according to the invention falls within the competence of those skilled in the art. The peptide substrates claimed may be obtained by normal solid phase synthesis methods (see for example Albericio, F. (2000). Solid-Phase Synthesis: A Practical Guide, I^{St} ed., CRC Press). It is thus possible to use, for example, the Boc strategy or the Fmoc strategy, both well known to those skilled in the art.

The protective groups that can be used for these syntheses are groups known to those skilled in the art. Said protective groups and use thereof are described in works such as for example Greene, “Protective Groups in Organic Synthesis”, Wiley, New York, 2007 4th edition; Harrison et al. “Compendium of Synthetic Organic Methods”, Vol. 1 to 8 (J. Wiley & sons, 1971 to 1996); Paul Lloyd-Williams, Fernando Albericio, Ernest Giralt. “Chemical Approaches to the Synthesis of Peptides and Proteins”, CRC Press, 1997 or Houben-Weyl, “Methods of Organic Chemistry, Synthesis of Peptides and Peptidomimetics”, Vol. E 22a, Vol. E 22b, Vol. E 22c, Vol. E 22d., M. Goodmann Ed., Georg Thieme Verlag, 2002. Depending on whether said protective groups are borne by a nitrogen atom, they will be designated as N-protective groups. The same is true for S-protective, O-protective groups, etc. For example, a hydroxyl may be protected by a trityl group or a carboxylic acid may be protected in the form of a tert-butylic ester. If a synthesis is carried out on solid support, it is the resin that serves as protective group to the carboxylic C-terminal carboxylic function.

In a preferred aspect of the invention, the chemistry used corresponds to the technology Fmoc and the protection of the side chains enabling their cleavage by trifluoroacetic acid (TFA), as described in “Fmoc solid phase peptide synthesis: a practical approach W. C. Chan and P. D. White Eds. Oxford University Press, 2004”. The acylation reaction to lead to the compounds of formula (I) may be carried out in the usual conditions known to those skilled in the art. According to a more particularly preferred aspect of the invention, those skilled in the art implement the Fmoc strategy on a paramethylbenzhydrylamine (pMBHA) resin, with the mixture O-Benzotriazole-N,N,N′,N′-tetramethyl-uronium-hexafluoro-phosphate (HBTU)/Hydroxybenzotriazole (HOBt)/N,N-Diisopropylethylamine (DIEA) as coupling agent. The deprotection of the side chains is obtained by action of a trifluoroacetic acid (TFA)/triisopropylsilane (TIPS)/H₂O mixture.

The peptides are purified by high performance liquid phase chromatography (HPLC). The identity of the peptides may be confirmed by any method known to those skilled in the art such as, for example, electrospray mass spectrometry. The intrinsic fluorescence of the peptide substrates of formula (I) is very low, given the spatial proximity between the fluorophore and the Rep repressor radical. The appearance of an intense fluorescence in the presence of Msp is linked to the generation, following an enzymatic cleavage, of a metabolite of generic formula (II)

Ac—(X)ₙ-Fluo (II)

in which Ac, X and n and Fluo have the same definitions as above.

The peptide substrates of the invention, as defined in formula (I), are highly specific for Msp. In fact, said peptides of formula (I) are not cleaved by other metalloenzymes such as pseudolysin, neprilysin, ACE, ECE, etc. On the other hand, the presence of one or several amino acids between the Fluo radical and the Rep radical lead to substrates that have lost their selectivity. They are then recognised by other peptidases such as pseudolysin.

The nature of the amino acids in position X or Z of formula (I) also strongly influences the specificity of the protease. In fact, the presence at one or the other of said positions of a hydrophobic amino acid, such as norleucine, leads to a compound that is not cleaved by Msp. Furthermore, the choice of the Rep radical is crucial. An amino acid more voluminous than (3-NO₂)-Tyr or (4-NO₂)Phe, such as 3,5 dinitro-tyrosine or DNP-lysine, leads to compounds that are not substrates, but which may be, optionally, inhibitors of Msp. In addition, the fluorescence exaltation observed after cleavage of substrates containing the couple pyrenylalanine/(3-NO₂)-Tyr is around 2 times greater than with substrates containing the couple pyrenylalanine/(4-NO₂)Phe.

The specificity of the peptides of formula (I) for Msp makes it possible to be able to affirm that all cleavage of a peptide of formula (I) is uniquely due to the action of Msp. Said cleavage results in fluorescence emission, caused by the physical separation of the Fluo rest and of the Rep rest. HPLC analysis of the reaction shows that there are only two metabolites, thus a single cleavage site and the appearance of the fluorescence demonstrates that the cleavage is located, as expected, between the fluorophore and the fluorescence repressor.

The second subject matter of the invention is a method for detecting the protease activity of Msp in a sample of a solution. “Solution” according to the present invention is taken to mean any solution in which the presence of Msp is suspected. Since Msp is a secreted protein, the solution according to the invention thus comprises any medium capable of containing Legionella pneumophila. This thus includes not just liquid cultures of Legionella pneumophila produced in the laboratory but also domestic hot water supplies or the waters of cooling towers, or instead lakes, rivers, ponds, basins or any other natural or artificial water body. A solution according to the invention may also comprise the protein Msp in partially or totally purified form. Such solutions may be obtained in the laboratory during steps of purification (an example of purification enabling to obtain such a solution of purified Msp is indicated in the experimental examples). In this respect, the detection of the proteasic activity of Msp may, for example, make it possible to monitor the purification of the protein.

The method for detecting the protease activity of Msp in a sample of a solution according to the invention comprises the steps of:

a) bringing into contact said sample with a compound of formula (I) as defined above, and

b) detecting a fluorescence emission.

Step a) of the method of the invention may be implemented over a wide range of temperatures. Advantageously, said temperature is comprised between 20° C. and 55° C.; preferentially, it is comprised between 25° C. and 45° C.; more preferentially, it is comprised between 30° C. and 40° C.; even more preferentially, it is comprised between 35° C. and 38° C. According to the most preferred embodiment of the invention, it is equal to 37° C.

A fluorescent molecule has the property of absorbing energy at a defined excitation wavelength and restoring it rapidly in the form of a fluorescent signal, at a defined emission wavelength. The fluorescence emission of step b) of the method is detected at a specific emission wavelength that depends on the fluorigenic group borne by the Fluo radical. The adjustment of said emission wavelength as a function of said fluorigenic group is within the capabilities of those skilled in the art. They, for example, know that the emission spectrum of pyrenylalanine has two maximums at 377 nm and 397 nm. They may thus use several wavelengths around said values to measure the fluorescence emission when the Fluo radical comprises a pyrenylalanine. Advantageously, the emission wavelength is comprised between 365 and 405 nm for pyrenylalanine. Preferentially, said wavelength is comprised between 370 and 400 nm. Even more preferentially, it is equal to 377 nm. The emission wavelength is advantageously 410 nm for aminobenzoyl and 420 nm for methoxycoumarinyl derivatives.

Just like the emission wavelength, the excitation wavelength is specific to the fluorigenic group borne by the Fluo radical. Once again, those skilled in the art are perfectly capable of adapting the excitation wavelength to said fluorigenic group. Advantageously, the excitation wavelength is 340 nm for pyrenylalanine, 310 nm for aminobenzoyl and 335 nm for methoxycoumarinyl derivatives.

The emission of fluorescence produced by the cleavage of a peptide of the invention by Msp may be detected using any means known to those skilled in the art as suitable for this purpose. Fluorimeters may be mentioned in particular among said means. Numerous types of fluorimeters exist and those skilled in the art will know how to identify the models that are the most suitable depending on their needs. In a preferred manner a spectrofluorimeter is used, which is useable over the whole range of wavelengths (200-800 nm) not just in excitation but also in emission. The fluorimeter has the advantage of being able to measure the intensity of the emitted fluorescence. Advantageously, the measurement of the fluorescence is repeated at regular intervals or not over time, in order to determine for example the kinetic parameters of the cleavage reaction. Even more advantageously, the cleavage reaction is monitored in a continuous manner over time.

The inventors have thus shown that the fluorimetric response varies in a linear manner as a function of the concentration in protease. It is thus possible, from a fluorescence value, to easily deduce what concentration of Msp said fluorescence value corresponds to. It is possible, for example, according to a technique well known to those skilled in the art, to establish a range of standards with known quantities of Msp to determine the quantity of Msp present in the sample.

The third subject matter of the present invention is thus a method for assaying Msp in a sample of a solution comprising the steps of:
a) detecting the protease activity of Msp according to the method described above,
b) measuring the fluorescence emission, and
c) deducing from the value of the fluorescence emission the quantity of Msp present in the sample.

Cases may exist where the quantity of Msp to be detected is very low. In other cases, the solution containing the Msp may also contain compounds inhibiting the proteasic activity of Msp. In these conditions, it may be advantageous to concentrate the enzyme before measuring the activity of the enzyme to increase the sensitivity of the test. The sample may thus be filtered and concentrated, for example by passing said sample on a Centricon filter. Preferably, said concentration step will make it possible to eliminate all the molecules of which the molecular weight is less than or equal to 25 kDa. It is also possible to carry out a selective enrichment in Msp protein, for example using an anti-Msp antibody not affecting the catalytic activity of said protease (in an affinity column or in an immunoprecipitation reaction) or an inhibitor column. The enrichment may also be non-selective, for example by concentration on magnetic beads. The method for assaying Msp according to the invention may thus comprise an additional step of concentrating the enzyme. Advantageously, this step is carried out before step a).

In a fourth aspect, the invention relates to a method for assaying Legionella pneumophila in a sample of a solution. In fact, the inventors have demonstrated that there exists a linear relationship between the quantity of Msp detected and the quantity of Legionella pneumophila present in said same sample.

The invention also relates to a method for assaying Legionella pneumophila in a sample of a solution, comprising the steps of:

a) assaying Msp in said sample according to the method described above, and

b) deducing therefrom the quantity of Legionella pneumophila.

The compounds of formula (I) are especially useful for identifying, detecting and assaying the presence of Legionella pneumophila in domestic hot water networks or cooling towers. Different cooling tower waters more or less contaminated by L. pneumophila have been tested with the aim of determining the presence of Msp by the fluorimetric assay developed in the preceding claim. Among all the tests carried out, no false positive was observed and the presence of Msp was detected in waters in which the contamination was low (less than 1000 UG/L). The present invention also proposes kits for detecting and assaying Legionella pneumophila, said kit containing at least one peptide of formula (I) as described above. Moreover, said kit advantageously comprises the reagents necessary for the measurement of the enzymatic activity. The kits according to the invention may be used in the laboratory or in the field.

### BRIEF DESCRIPTION OF THE FIGURES

The figures and examples hereafter are presented for illustrating and non-limiting purposes, for the present invention.

FIG. 1: Specificity of the fluorigenic substrate towards Msp-Comparative cleavage of compound 8 (10 μM) by 10 ng/mL of Msp and pseudolysin, pepsin, papain, neprilysin (NEP), conversion enzyme of endotheline-1 (ECE-1) and 2 (ECE-2), the protease of HIV 5 (HIV P.) as well as by trypsin. The fluorescence deltas (U.A.) are represented after 300 minutes of incubation at 37° C. in 50 mM HEPES, pH 7.

FIG. 2: Comparison of the degradation of compound 1 and 2 compounds EF and EL of respective formula Ac—(X)n-Pya-EF-(3-NO₂)Tyr-(Gly)m-Z—NH₂ and Ac—(X)n-Pya-EL-(3-NO₂)Tyr-(Gly)m-Z—NH₂ by Msp and Pseudolysin. The substrates (10 μM) are incubated for 120 minutes at 37° C. with 10 ng/mL of purified Msp or pseudolysin in 50 mM HEPES, pH 7.

FIG. 3: Comparison of the degradation of compound 1 and compounds Nop of formula Ac—(X)ₙ-Pya-(NO₂)Phe-(Gly)m-Z—NH₂ and 3,5-NO₂ Tyr of formula Ac—(X)n-Pya-(3,5-(NO₂)₂)Tyr-(Gly)m-Z—NH₂ by Msp. The substrates (10 μM) are incubated for 300 minutes at 37° C. with 2 ng/mL of purified Msp in 50 mM HEPES, pH 7.

FIG. 4: Comparison of the degradation (evolution of the fluorescence) as a function of time of compound 1 and of the compound Nle of formula Ac—S-Me-G-Pya-(3-NO₂)Tyr-(Gly)m-Z—NH₂ by the Msp. The substrates (10 μM) are incubated for 240 minutes at 37° C. with 10 ng/mL of purified Msp in 50 mM HEPES, pH 7. The readings are carried out with the Berthold LS970B at λex=340 nm, λem=405 nm and the energy of the lamp at 10000.

FIG. 5: Emission fluorescence spectrum of compound 1 (c: 100 μM) (triangles) and the fluorescent metabolite thereof (c: I μM) (squares). The peptides are in solution in 50 mM HEPES buffer, pH 7. On the abscissa: the wavelengths expressed in nm. On the ordinates: the fluorescence intensity expressed in fluorescence arbitrary units (AU). The spectrum is recorded on a Perkin Elmer LS50B apparatus. (λex=343 nm, excitation slit: 15, emission slit: 2.5). Ratio of fluorescence intensities at 377 nm: I(metabolite)/I(substrate)=20000.

FIG. 6: Detection of Msp in 50 mM HEPES buffer, pH 7.

6a) Evolution of the fluorescence (expressed in Δ of fluorescence) as a function of time (min). The test is carried out in a 96 microwell plate at 37° C., in a final volume of 100 μL, in the presence of a concentration of compound 1 of 10 μM and concentrations of Msp varying from 0.1 to 30 ng/mL.

6b) Linearisation of the variation in fluorescence as a function of the concentration of Msp (pg in 100 μL) varying from 0.1 to 10 ng/mL after an incubation of 90 min. Analogous results are obtained at 30, 60 and 120 min.

FIG. 7:

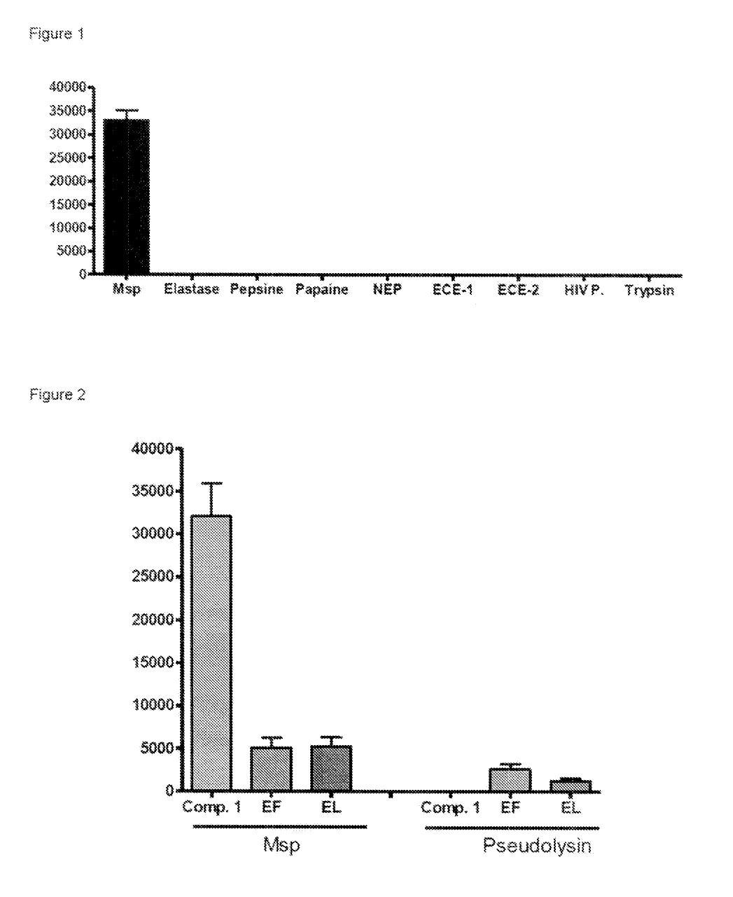

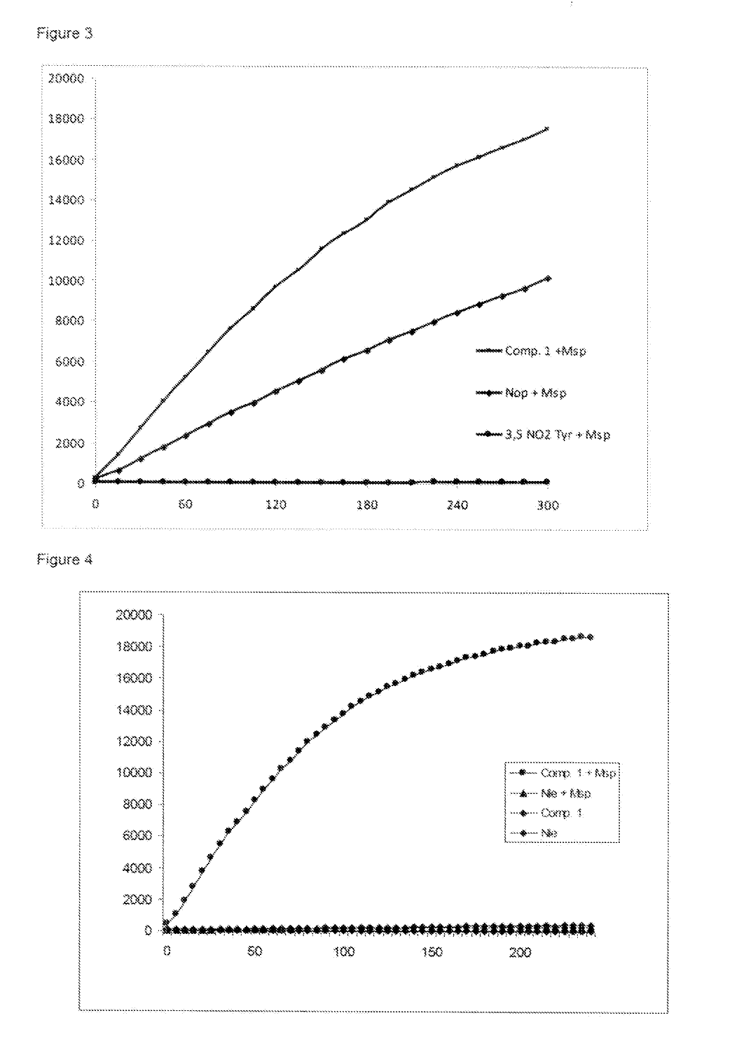

7a) Relation between the quantity of Msp present in a culture supernatant (reflected by the variation in fluorescence of compound 1) and the quantity of Legionella pneumophila enumerated in a culture medium. The test is carried out in a microwell at 37° C., in a final volume of 100 μL, in the presence of a concentration of compound 1 of 10 μM and serial dilutions of a culture supernatant from 1/1000 to 1/20000.

7b) Linearisation of the variation in fluorescence as a function of the enumeration (UFC/mL) in Legionella pneumophila after an incubation of 90 min. The enumeration was carried out according to the protocol of the AFNOR NF R90-431 standard.

FIG. 8:

8a) Variation in fluorescence induced by cleavage of compounds 1, 8 and 12 by purified Msp as a function of time. The test is carried out in 50 mM HEPES buffer, pH 7 with a concentration of substrate of 10 μM and a concentration of Msp of 10 ng/mL. The readings are taken with a Berthold LS970B at λex=340 nm, λem=405 nm and the energy of the lamp at 10000.

8b) Determination of the kinetic parameters of compound 1. Variation in the rate of degradation by Msp (2 ng/ml) after an incubation of 30 min at 37° C. as a function of the concentration of compound 1 (μM). The test is carried out in 50 mM HEPES buffer, pH 7 with a concentration of substrate of 10 μM and a concentration of Msp of 10 ng/mL. The readings are taken with a Berthold LS970B at λex=340 nm, λem=405 nm and the energy of the lamp at 10000.

### EXAMPLES

### Example 1

### Preparation of Substrates

The peptide substrates (I) and the fluorescent metabolites thereof (II) are prepared in solid phase on an automatic synthesiser using the Fmoc strategy and the conventional protocol of coupling HBTU/HOBt/DIEA on a MBHA resin for the substrates and on a HMP resin for the fluorescent metabolites. The functionalised side chains are protected in the form of t-butyl ethers (Ser or homo-Ser), Pmc (Arg, homo-Arg) or Boc (Lys, homo-Lys, Om) as described in “Fmoc solid phase peptide synthesis: A practical approach. W. C. Chan and P. D. White Eds. Oxford University Press, 2004”.

The couplings are carried out in N-methyl-pyrrolidone (NMP) with 10 amino acid equivalents. The fluorophore is introduced by coupling in a syringe in the presence of BOP/DIEA. The N-terminal amino acid is introduced directly in N-acetylated derivate form. The deprotection of the side chains is obtained in 2 h by action of a TFA/TIPS/H₂O mixture: (95/2.5/2.5) at ambient temperature.

The peptides are purified by semi-preparative HPLC on a Waters 600 apparatus equipped with a UV 2487 detector, on a ACE C18 100 Å column, 5 μm, 250×20 mm or Atlantis T3, 3.5 μm, 100×20 mm with as elution system a mixture of CH₃CN (0.1% TFA)/H₂O (0.1%) TFA) in variable proportion. Their purity is verified by analytical HPLC, on an ACE 100 Å column, 5 μm, or Atlantis T3, 3.5 μm, 100×4.6 mm on a HPLC Shimadzu Prominence with a UV spectrometer for the detection. The peptides are analysed by Electrospray Mass Spectrometry in positive mode on a LCMS Agilent series 1200 detection simple Quad.

The following examples illustrate the present application, without limiting it:

Compound 1—Ac-Ser-Lys-Gly-Pya-(3-NO₂)Tyr-Gly-Gly-Lys-NH₂

HPLC ACE 100 Å, 5 μm, C18 250×4.6 mm CH₃CN (0.1% TFA)/H₂O (0.1% TFA) 10 to 90 in 30 min; Rt: 13.69 min. ESI Mass(+): [(M+2H)/2]⁺=527.4

Compound 2—Ac-Ser-Lys-Gly-Pya-(3-NO₂)Tyr-Gly-Lys-NH₂

HPLC ACE 100 Å, 5 μm, C18 250×4.6 mm CH₃CN (0.1% TFA)/H₂O (0.1% TFA) 10 to 90 in 30 min; Rt: 13.09 min. ESI Mass(+): [(M+2H)/2]⁺=498.9

Compound 3—Ac-Ser-Lys-Gly-Pya-(3-NO₂)Tyr-Lys-NH₂

HPLC ACE 100 Å, 5 μm, C18 250×4.6 mm CH₃CN (0.1% TFA)/H₂O (0.1% TFA)30/70; Rt: 12.87 min. ESI Mass(+): [(M+2H)/2]⁺=470.3

Compound 4—Ac-Ser-Arg-Gly-Pya-(3-NO₂)Tyr-Gly-Gly-Lys-NH₂

HPLC ACE 100 Å, 5 μm, C18 250×4.6 mm CH₃CN (0.1% TFA)/H₂O (0.1% TFA) 0 to 5 30% in 20 min then 30% 10 min; Rt: 29.83 min. ESI Mass(+): [(M+2H)/2]⁺=541.4

Compound 5—Ac-Arg-Gly-Pya-(3-NO₂)Tyr-Gly-Gly-Lys-NH₂

HPLC Atlantis T3, 3.5 μm, 100×4.6 mm CH₃CN (0.1% TFA)/H₂O (0.1% TFA) 28/72; Rt: 15.40 min. ESI Mass(+): [(M+2H)/2]⁺=497.8

Compound 6—Ac-Ser-homo-Arg-Gly-Pya-(3-NO₂)Tyr-Gly-Gly-Lys-NH₂

HPLC Atlantis T3, 3.5 μm, 100×4.6 mm CH₃CN (0.1% TFA)/H₂O (0.1% TFA) 30/70; Rt: 13.21 min. ESI Mass(+): [(M+2H)/2]⁺=548.5

Compound 7—Ac-Ser-Orn-Gly-Pya-(3-NO₂)Tyr-Gly-Gly-Lys-NH₂

HPLC ACE 100 Å, 5 μm, CI8 250×4.6 mm CH₃CN (0.1% TFA)/H₂O (0.1% TFA) 25/75%; Rt: 41.62 min. ESI Mass(+): [(M+2H)/2]⁺=520.5

Compound 8—Ac-Ser-Lys-Gly-Pya-(3-NO₂)Tyr-Orn-NH₂

HPLC Atlantis T3, 3.5 μm, 100×4.6 mm CH₃CN (0.1% TFA)/H₂O (0.1% TFA) 10 to 90% in 15 min; Rt: 9.02 min. ESI Mass(+): [(M+2H)/2]⁺=477.8

Compound 9—Ac-Ser-Lys-Gly-Pya-(3-NO₂)Tyr-homo-Lys-NH₂

HPLC Atlantis T3, 3.5 μm, 100×4.6 mm CH₃CN (0.1% TFA)/H₂O (0.1% TFA) 10 to 20 90% in 15 min; Rt: 8.97 min. ESI Mass(+): [(M+2H)/2]=463.5

Compound 10—Ac-homo-Ser-Lys-Gly-Pya-(3-NO₂)Tyr-Orn-NH₂

HPLC ACE 100 Å, 5 μm, C18 250×4.6 mm CH₃CN (0.1% TFA)/H₂O (0.1% TFA)30/70; Rt: 13.70 min. ESI Mass(+): [(M+2H)/2]⁺=470.5

Compound 11—Ac-Ser-Lys-Gly-Pya-(3-NO₂)Tyr-Arg-NH₂

HPLC ACE 100 Å, 5 μm, C18 250×4.6 mm CH₃CN (0.1% TFA)/H₂O (0.1% TFA) 30/70; Rt: 10.28 min. ESI Mass(+): [(M+2H)/2]⁺=484.0

Compound 12—Ac-Ser-Lys-Gly-Pya-(3-NO₂)Tyr-homo-Arg-NH₂

HPLC ACE 100 Å, 5 μm, C18 250×4.6 mm CH₃CN (0.1% TFA)/H₂O (0.1% TFA) 30/70; Rt: 11.25 min. ESI Mass(+): [(M+2H)/2]⁺=491.5

Compound 13—Ac-Ser-Lys-Gly-(ε-Abz)Lys-(3-NO₂)Tyr-Orn-NH₂

Atlantis T3, 3.5 μm, 100×4.6 mm CH₃CN (0.1% TFA)/H₂O (0.1% TFA) 15/85; Rt: 7.24 min. ESI Mass(+): [(M+2H)/2]⁺=451.6

### Example 2

### Comparison of the Fluorescence Emitted by the Substrates and the Fluorescent Metabolites Thereof

The excitation wavelengths of the preceding substrates are: λex=340 nm when the fluorophore is a pyrenylalanine, λex=310 nm for aminobenzoyl group and λex=335 nm for methoxycoumarinyl derivatives.

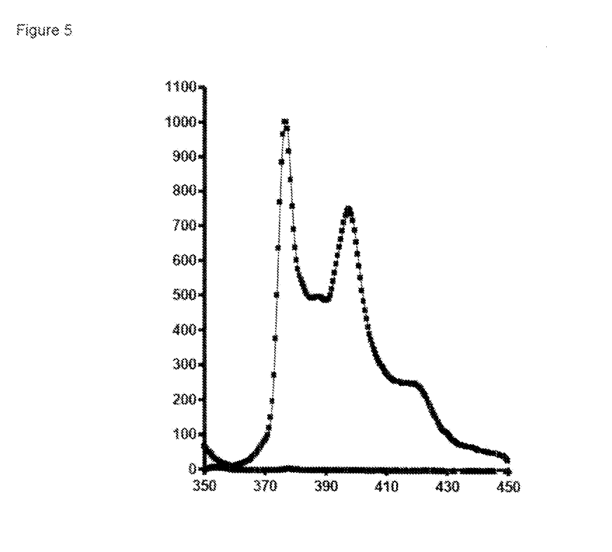

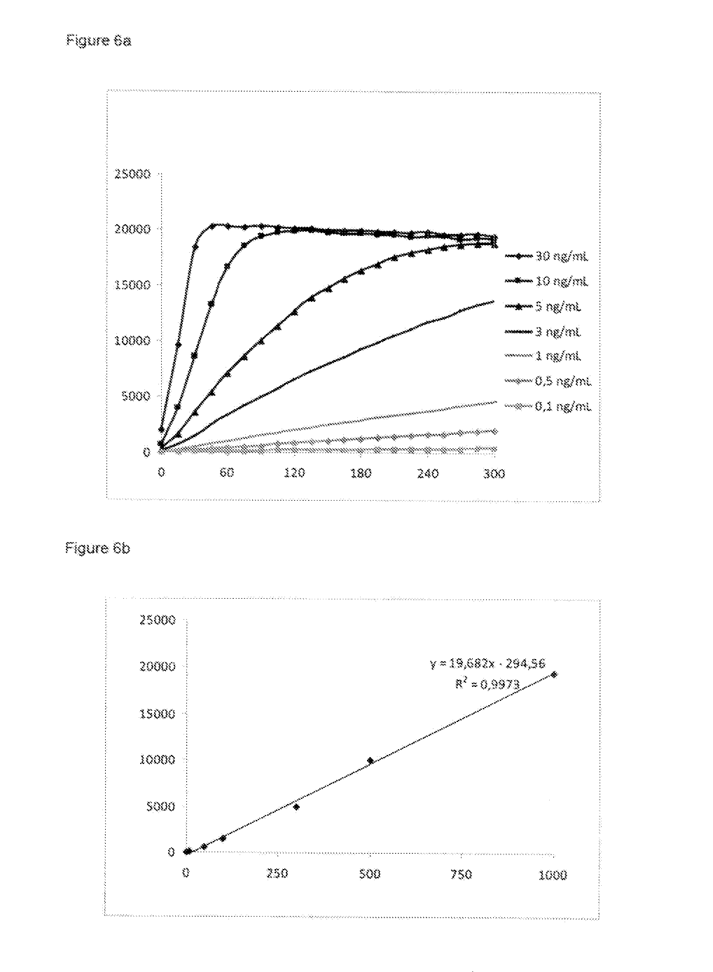

The different substrates and the fluorescent metabolites thereof are solubilised in 50 mM HEPES buffer solution, pH 7.0 at the respective concentrations of 10⁻⁴ M and 10⁻⁶ M. The fluorescence spectra are recorded with a Perkin Elmer LS50B fluorimeter. For the compounds 1 to 12, which contain Pya as fluorophore, the emission spectra obtained, after excitation at 343 nm, show two maximums at 377 and 397 nm (FIG. 5), enabling readings at several wavelengths around these values and λem=410 nm for aminobenzoyl (compound 13); λem=420 nm for Mca.

### Example 3

### Purification of Msp

The Msp is purified from broth culture supernatants of 3 litres of Legionella pneumophila from the Paris strain according to a protocol based on the initial data of Dreyfus and Iglewski, Infect. Immun., 1986, 51, 736-743.

The culture supernatant is firstly precipitated with 65% ammonium sulphate overnight at 4° C. After centrifugation (10000 rpm, 60 minutes at 4° C.), the residue is taken up in around 200 mL of equilibration buffer (25 mM Tris pH 7.8, 25 mM NaCl, 0.01% triton×100) and dialysed at 4° C. overnight. The dialysed precipitate is then loaded on a DEAE FF 16/10 column (HiPrep, GE Healthcare) using an Akta purifier (GE Healthcare). The proteins retained on the column are eluted over three stages of concentration of the elution buffer, the first to 15% of buffer B (25 mM Tris pH 7.8, 1M NaCl, 0.01%) triton×100), the second to 60% and the last to 100%. The enzymatic activity corresponding to the Msp is tested in each fraction of the second stage using a fluorescent substrate. The fractions containing the enzymatic activity are also analysed on SDS PAGE 10% (BioRad) in non-denaturing conditions, and gels coloured with silver nitrate (Sigma). The fractions containing the Msp enzymatic activity are combined, washed with the equilibration buffer from the second step of purification, 50 mM Tris pH 7.2, 150 mM NaCl, 0.01% triton×100 and concentrated on a Centricon YM10 (Amicon). The concentrated “pool” thereby obtained is then loaded on a HiLoad 16/60 Superdex 75 column (GE Healthcare) and the proteins eluted with the equilibration buffer at a flow rate of 0.25 mL/min. The fractions containing Msp are combined and concentrated after measurement of the enzymatic activity and electrophoresis of the fractions. The purity of the preparation obtained is verified on electrophoresis gel. If necessary, said preparation may be subjected to a third step of purification on a Superdex 10/300 gel filtration column.

### Example 4

### Assay of Msp by the Fluorigenic Substrate

The assay is carried out on a preparation of purified protease. The test is carried out in a 96 microwell plate in a final volume of 100 μL in 50 mM HEPES buffer, pH 7.0 at 37° C. The Msp is used at 10 ng/mL and the substrate is at a final concentration of 10 μM. The variation in fluorescence is continuously monitored as a function of time in a Twinkle LB 970 (Berthold) microwell reader having filters with pass bands of ±15 nm. For substrates 1 to 12, having pyrenylalanine as fluorophore, the excitation and emission wavelengths are respectively λex=340 nm, λem=405 nm. As an example, the variation in fluorescence obtained in the conditions indicated above with substrates 1, 8 and 12 is presented in FIG. 8a.

The kinetic parameters of substrate 1 vis-à-vis Msp are (FIG. 8b):

Km=6.8±0.6 μM kcat=23.9±0.7 s⁻¹

The sensitivity of the substrate 1 has been established by measuring the fluorescence emitted, as a function of time, by hydrolysis of a given concentration of the substrate (10 μM) by lower and lower quantities of Msp.

### Example 5

### Relation Between the Quantity of Msp Detected in the Culture Supernatants and the Quantity of Legionella pneumophila Enumerated in Said Same Cultures

The test is carried out in a 96 microwell plate in a final volume of 100 μL in 50 mM HEPES buffer, pH 7 at 37° C. The Msp is used at 10 ng/mL and the substrate is at a final concentration of 10 μM.

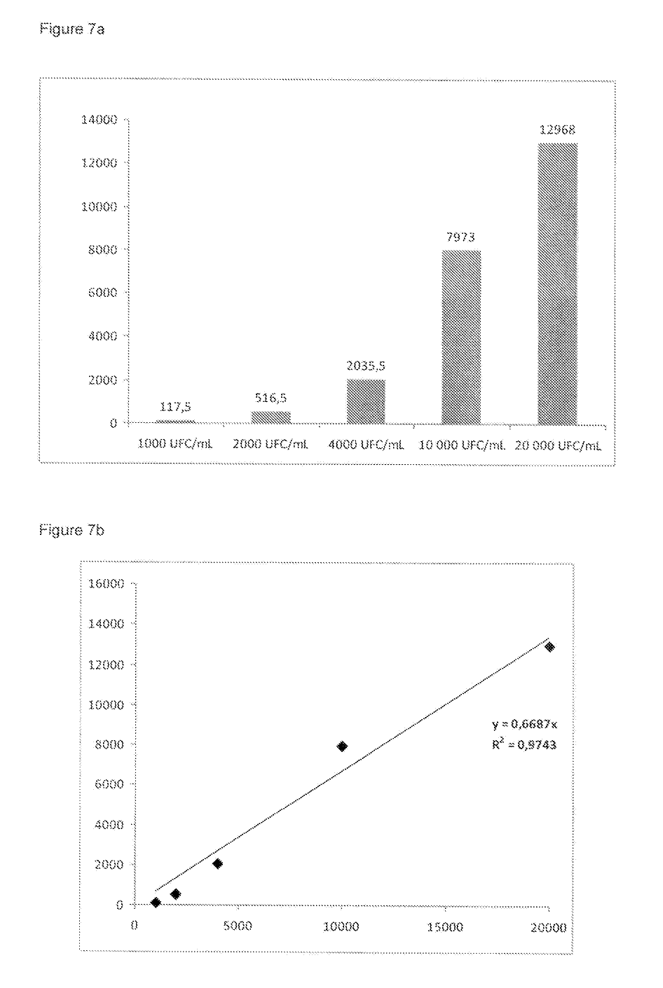

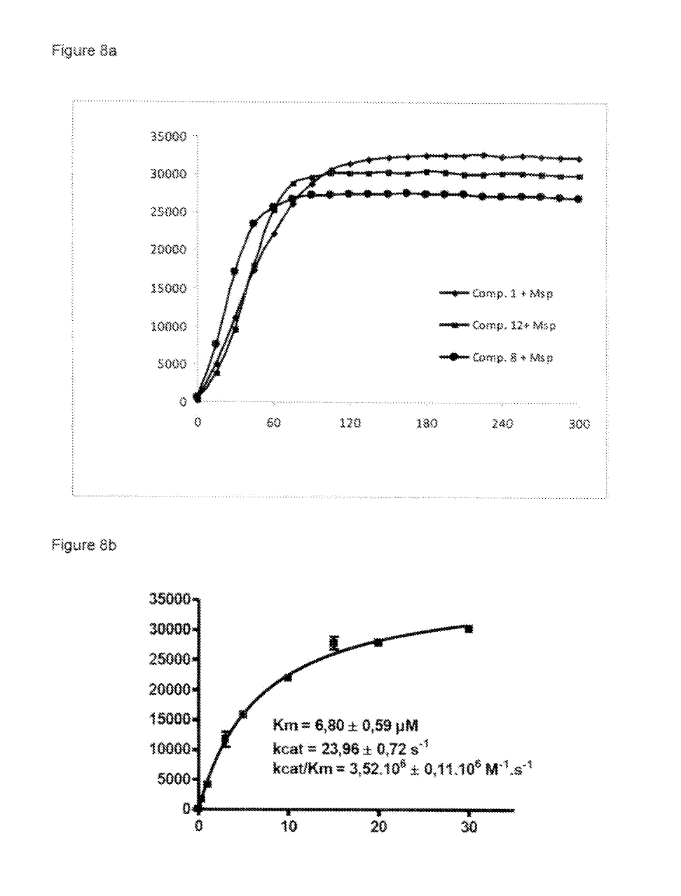

A first correlation is established between the quantity of Msp present in a sample and the intensity of the fluorescence emitted for a determined quantity of substrate at different times (FIG. 7). It was then important to verify that there exists a correlation between the quantity of Msp released in a culture medium and the quantity of Legionella pneumophila in said same medium. These quantifications have been established from different culture media, the enumeration of which was carried out according to the protocol of the AFNOR NF R90-431 standard and the Msp quantified from the fluorimetric assay described in the preceding claim. In stationary growth phase a linear correlation is observed between the quantity of Legionella present and the quantity of Msp released in the medium (FIGS. 7a and 7b).

1-17. (canceled)

18. A peptide substrate selective for a Major Secreted Protein (Msp) of Legionella pneumophila, of formula (I):
R—(X)ₙ-Fluo-Rep-(Gly)ₘ-Z—NH₂ (I)
in which,
Fluo is an α-amino acid of configuration (L), having on its side chain a fluorigenic group,
Rep is an amino acid of configuration (L) selected from (3-NO₂)Tyr and (4-NO₂)Phe, on the understanding that when Fluo is pyrenylalanine, Rep is (3-NO₂)Tyr,
R is a group selected from the groups acetyl, succinyl and methoxysuccinyl,
X is an α-amino acid of configuration (L) selected from the group consisting of: Gly, Ser, homo-Ser, Lys, homo-Lys, Arg, homo-Arg and Orn,
Z is a positively charged α-amino acid, and
n and m are two natural whole numbers, with n comprised between 0 and 3 and m comprised between 0 and 2.

19. The peptide according to claim 18, wherein the Fluo radical is selected from the group consisting of (L)-(I-pyrenyl)-alanine, (L)-Nε(retroAbz)-Lys, (L)-(7-methoxycoumarin-4-yl)-alanine, (L)-((6,7-dimethoxy-coumarin-4-yl)-alanine, (L)-Nβ(pyrenylacetyl)-Dap, (L)-Nγ(pyrenylacetyl))-Dab, (L)-Nδ-(pyrenylacetyl)-Orm, (L)-Nε-(pyrenylacetyl)-Lys, (L)-S—(I-pyrenemethyl)-Cys and (L)-O—(I-pyrenemethyl)-Ser.

20. The peptide according to claim 19, wherein the Fluo radical is (L)-(I-pyrenyl)-alanine.

21. The peptide according to claim 18, wherein the Rep radical is (3-NO₂)Tyr.

22. The peptide according to claim 18, wherein Z is selected from the group consisting of (L)-Lys, (L)-homo-Lys, (L)-Orn, (L)-Arg and (L)-homo-Arg.

23. The peptide according to claim 18, wherein the peptide is selected from the group consisting of:
Compound 1- Ac-Ser-Lys-Gly-Pya-(3-NO₂)Tyr-
Gly-Gly-Lys-NH₂,
Compound 2- Ac-Ser-Lys-Gly-Pya-(3-NO₂)Tyr-
Gly-Lys-NH₂,
Compound 3- Ac-Ser-Lys-Gly-Pya-(3-NO₂)Tyr-Lys-NH₂,
Compound 4- Ac-Ser-Arg-Gly-Pya-(3-NO₂)Tyr-Gly-
Gly-Lys-NH₂,
Compound 5- Ac-Arg-Gly-Pya-(3-NO₂)Tyr-Gly-
Gly-Lys-NH₂,
Compound 6- Ac-Ser-homo-Arg-Gly-Pya-(3-NO₂)Tyr-
Gly-Gly-Lys-NH₂,
Compound 7- Ac-Ser-0rn-Gly-Pya-(3-NO₂)Tyr-Gly-
Gly-Lys-NH₂,
Compound 8- Ac-Ser-Lys-Gly-Pya-(3-NO₂)Tyr-0rn-NH₂,
Compound 9-Ac-Ser-Lys-Gly-Pya-(3-NO₂)Tyr-
homo-Lys-NH₂,
Compound 10 -Ac-homo-Ser-Lys-Gly-Pya-
(3-NO₂)Tyr-Orn-NH₂,
Compound 11 -Ac-Ser-Lys-Gly-Pya-(3-NO₂)Tyr-Arg-NH₂,
Compound 12 -Ac-Ser-Lys-Gly-Pya-(3-NO₂)Tyr-
homo-Arg-NH₂,
and
Compound 13 -Ac-Ser-Lys-Gly-(ε-Abz)Lys-
(3-NO₂)Tyr-0rn-NH₂.

24. The peptide according to claim 23, wherein the peptide is selected from the group consisting of:
Compound 1- Ac-Ser-Lys-Gly-Pya-(3-NO₂)Tyr-Gly-Gly-
Lys-NH₂,
Compound 8- Ac-Ser-Lys-Gly-Pya-(3-NO₂)Tyr-Orn-NH₂,
and
Compound 12- Ac-Ser-Lys-Gly-Pya-(3-NO₂)Tyr-
homoArg-NH₂.

25. A method for detecting protease activity of a Major Secreted Protein (Msp) of Legionella pneumophila in a sample of a solution comprising:
a) placing in contact the sample with a compound of formula (I);
R—(X)ₙ-Fluo-Rep-(Gly)ₘ-Z—NH₂ (I)
in which,
Fluo is an α-amino acid of configuration (L), having on its side chain a fluorigenic group,
Rep is an amino acid of configuration (L) selected from (3-NO₂)Tyr and (4-NO₂)Phe, on the understanding that when Fluo is pyrenylalanine, Rep is (3-NO₂)Tyr,
R is a group selected from the groups acetyl, succinyl and methoxysuccinyl,
X is an α-amino acid of configuration (L) selected from the group consisting of: Gly, Ser, homo-Ser, Lys, homo-Lys, Arg, homo-Arg and Orn,
Z is a positively charged α-amino acid, and
n and m are two natural whole numbers, with n comprised between 0 and 3 and m comprised between 0 and 2; and
b) detecting a fluorescence emission.

26. The method according to claim 25, wherein step a) is carried out at a temperature comprised between 20° C. and 55° C.

27. The method according to claim 26, wherein the temperature is equal to 37° C.

28. The method for assaying Major Secreted Protein (Msp) of Legionella pneumophila in a sample of a solution comprising the steps of:
a) detecting the protease activity of Msp according to the method of claim 8;
b) measuring the fluorescence emission; and
c) deducing from the value of the fluorescence emission the quantity of Msp present in the sample.

29. The method for assaying Msp according to claim 28, further comprising an additional step of concentrating the enzyme before step a).

30. The method for assaying Msp according to claim 29, wherein the concentration of the sample is carried out before step a).

31. The method for assaying Legionella pneumophila in a sample of a solution, comprising:
a) assaying Msp in the sample according to the method of claim 28; and
b) deducing therefrom the quantity of Legionella pneumophila.

32. The method according to claim 25, wherein the solution is a medium capable of containing bacteria of Legionella pneumophila type.

33. The method according to claim 32, solution is a domestic hot water or a cooling tower water.

34. A kit for detecting and assaying Legionella pneumophila, the kit comprising at least one peptide according to:
R—(X)ₙ-Fluo-Rep-(Gly)ₘ-Z—NH₂ (I)
in which,
Fluo is an α-amino acid of configuration (L), having on its side chain a fluorigenic group,
Rep is an amino acid of configuration (L) selected from (3-NO₂)Tyr and (4-NO₂)Phe, on the understanding that when Fluo is pyrenylalanine, Rep is (3-NO₂)Tyr,
R is a group selected from the groups acetyl, succinyl and methoxysuccinyl,
X is an α-amino acid of configuration (L) selected from the group consisting of: Gly, Ser, homo-Ser, Lys, homo-Lys, Arg, homo-Arg and Orn,
Z is a positively charged α-amino acid, and
n and m are two natural whole numbers, with n comprised between 0 and 3 and m comprised between 0 and 2.


SEQUENCE LISTING (13 sequences)

SEQ ID NO: 1 - protein, 8 aa, artificial
  peptide substrate
SKGXYGGK

SEQ ID NO: 2 - protein, 7 aa, artificial
  peptide substrate
SKGXYGK

SEQ ID NO: 3 - protein, 6 aa, artificial
  peptide substrate
SKGXYK

SEQ ID NO: 4 - protein, 8 aa, artificial
  peptide substrate
SRGXYGGK

SEQ ID NO: 5 - protein, 7 aa, artificial
  peptide substrate
RGXYGGK

SEQ ID NO: 6 - protein, 8 aa, artificial
  peptide substrate
SRGXYGGK

SEQ ID NO: 7 - protein, 8 aa, artificial
  peptide substrate
SXGXYGGK

SEQ ID NO: 8 - protein, 6 aa, artificial
  peptide substrate
SKGXYX

SEQ ID NO: 9 - protein, 6 aa, artificial
  peptide substrate
SKGXYK

SEQ ID NO: 10 - protein, 6 aa, artificial
  peptide substrate
SKGXYX

SEQ ID NO: 11 - protein, 6 aa, artificial
  peptide substrate
SKGXYR

SEQ ID NO: 12 - protein, 6 aa, artificial
  peptide substrate
SKGXYR

SEQ ID NO: 13 - protein, 6 aa, artificial
  peptide substrate
SKGKYX